(19) United States
(12) Patent Application Publication
(10) Pub. No.: US 2011/0191986 A1
(43) Pub. Date: Aug. 11, 2011

(54) ADJUSTABLE DOOR HANGER

(75) Inventor: James Gregory Smith, Bethel Park, PA (US)

(73) Assignee: Bombardier Transportation GmbH, Berlin (DE)

(21) Appl. No.: 12/701,938

(22) Filed: Feb. 8, 2010

(51) Int. Cl. E05D 15/06; B23P 17/04

(52) U.S. Cl. 16/87 R; 29/428

(57) ABSTRACT

An adjustable door hanger for a sliding door assembly comprises an operator interface and door panel interface connected to the operator interface. The door panel interface is adapted to adjustably engage a door panel such that the door panel is pivotable about the door panel interface. The door panel interface may then be pivoted to a desired resting position. The hanger may include a door panel top rail for receiving the door panel interface. The door panel may be fixed to the door panel interface after pivoting to the desired resting position. A method of hanging a sliding door panel includes providing a door hanger having a door panel interface, attaching a door panel to and pivoting the door panel about the door panel interface to a desired resting position and securing the door panel to the door panel interface.

### BACKGROUND OF THE INVENTION

1. Field of the Invention

The present invention relates to a hanger assembly, and, more particularly, to a hanger for a sliding door and a method of hanging a sliding door.

2. Description of Related Art

Sliding doors are those that open horizontally by sliding. Sliding doors are typically mounted to an overhead door operator, such as track, drive or actuator assembly, such as the doors on a people mover vehicle or light rail car. Oftentimes, during assembly, the sliding doors can become misaligned with the overhead track, drive or actuator assembly. The amount a door, or door panel, can be adjusted to account for the misalignment is often limited by the amount of tolerance stack-up between the door panel and the overhead operator. Further, a sliding door and overhead track, drive or actuator assembly may not be correctly dimensioned prior to installation such that the door and overhead operator are optimally aligned. In some cases, tapered shims must be installed into the overhead assembly to achieve acceptable alignment between the door and the overhead assembly. Once the door is fixed in position, and the vehicle has been fully setup, it becomes laborious and expensive to correct any door misalignments. Further, any misalignment can result in damage to door operators due to excessive force and wear to the door operator.

Therefore, there exists a need for a hanger assembly for a sliding door that is capable of adjustable during installation.

### SUMMARY OF THE INVENTION

Provided herein is an adjustable door hanger. The door hanger includes a door operator interface and a door panel interface that is connected to the door operator interface. The door panel interface is adapted to adjustably engage a portion of a door panel such that the door panel swivels about the door panel interface.

Also provided herein is a method of hanging a sliding door panel. The method includes providing a door hanger having an operator interface and a door panel interface connected to the operator interface. Other steps include connecting the operator interface to an overhead door operator assembly and subsequently attaching the door panel such that the door panel swivels about the door panel interface. The door panel is then pivotally adjusted about the door panel interface until a desired resting position of the door panel is determined and secured in place.

### BRIEF DESCRIPTION OF THE DRAWINGS

These and other features, aspects, and advantages of the present invention may become better understood when the following detailed description is read with reference to the accompanying figures in which like characters represent like parts throughout the figures.

FIG. 1 is a diagrammatical representation of a door hanger according to one embodiment of the present invention;

FIG. 2 is a diagrammatical representation of a cross-section of the door hanger and a corresponding door panel top rail portion in accordance with another embodiment of the present invention;

FIG. 3 is a diagrammatical representation of the door hanger as shown in FIG. 1, illustrating a plurality of apertures on both the door operator interface and the door panel interface in accordance with another embodiment of the present invention;

FIG. 4 is a diagrammatical representation of the door hanger and the door panel top rail portion illustrating the matching patterns between the pairs of plurality of apertures in the door panel top rail portion and the plurality of apertures in the door panel interface in accordance with yet another embodiment of the present invention;

FIG. 5 is a diagrammatical representation of a cross-section of the door hanger and the door panel top rail portion illustrating a fastening means in accordance with yet another embodiment of the present invention;

FIG. 6 is a diagrammatical representation of the swiveling motion of the door panel top rail portion about the door hanger in accordance with yet another embodiment of the present invention; and

FIG. 7 is a diagrammatical representation of an exemplary engagement between the door hanger and a portion of a door panel including a top rail portion in accordance with another embodiment of the present invention.

### DESCRIPTION OF THE PREFERRED EMBODIMENTS

For purposes of the description hereinafter, spatial orientation terms, if used, shall relate to the referenced embodiment as it is oriented in the accompanying drawing figures or otherwise described in the following detailed description. However, it is to be understood that the embodiments described hereinafter may assume many alternative variations and embodiments. It is also to be understood that the specific devices and methods illustrated in the accompanying drawing figures and described herein are simply exemplary and should not be considered as limiting.

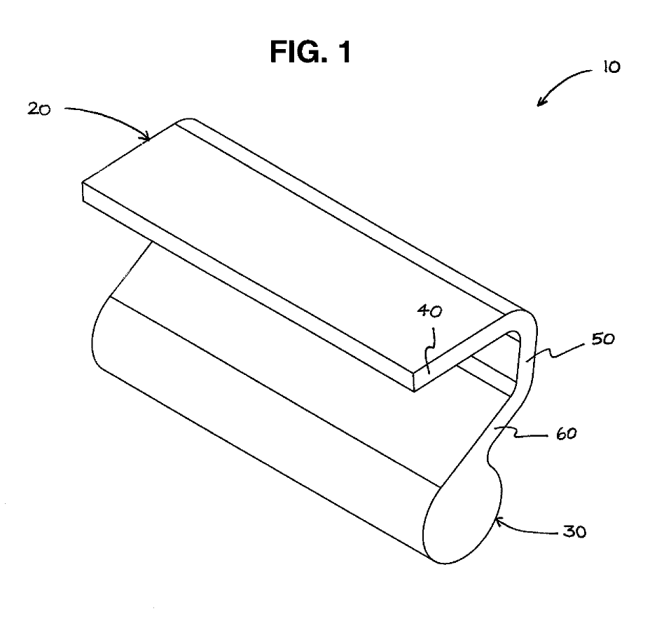

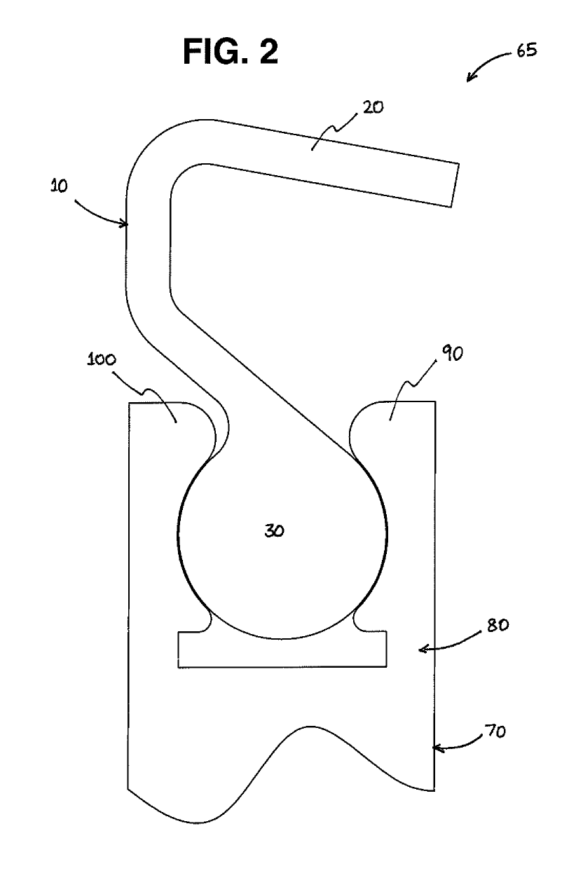

Turning now to the drawings and referring first to FIG. 1, one embodiment of adjustable door hanger 10 in accordance with one aspect of the present invention is illustrated. The door hanger 10 includes a door operator interface 20 and a door panel interface 30. Optionally as shown, the door operator interface 20 and door panel interface 30 may be a single integrally formed door hanger 10, or, alternatively, the door operator interface 20 and door panel interface 30 may comprise two separate components. The door panel interface 30 is adapted to adjustably engage a door panel 70 (shown in FIG. 2) such that the door panel swivels about the door panel interface 30 of the hanger 10. The door operator interface 20, in one embodiment, may be ‘L’ shaped, with two legs 40, 50 each including first and second ends, wherein the second end of the first leg 40 and the first end of the second leg 50 are connected. In one embodiment, the first and second legs 40, 50 may be substantially perpendicular to each other, while in another embodiment, as shown in FIG. 1, the door operator interface 20 may include legs 40, 50 that are not perpendicular to each other. The angle between the legs 40, 50 is purely a function of arrangement to allow a successful interface between the door hanger 10 and the door panel. Furthermore, in the present embodiment, the door operator interface 20 is shown as being monolithic or made from a single substance, steel or aluminum for example. In an alternative embodiment, the door operator interface 20 may be composed of dissimilar materials that are fastened together appropriately.

The door hanger 10 further includes a neck portion 60 that extends from one of the two legs of the door operator interface 20. In the illustrated embodiment, the neck portion 60 extends from the second end of the leg 50. The neck portion 60 bridges and connects the door operator interface 20 and the door panel interface 30. In one embodiment, the neck portion 60 is merely an extension of the leg 50 that is bent in order to properly suit the application. In another embodiment, the neck portion 60 may comprise a different material from the operator interface, whereas in yet another embodiment, the neck portion 60 may be omitted entirely with the second end of the second leg 50 connecting directly to door panel interface 30. The choice of the size, shape, length and material of the neck portion 60 is purely a matter of function for any particular application. It is typically determined by the amount of space that is required between the door operator interface 20 and the door panel interface 30 in a particular environment.

The door panel interface 30, as shown in FIG. 1, has a substantially circular cross-section. In other embodiments, the shape of the door panel interface 30 may be altered to provide a different kind of alignment freedom. Such modifications should be considered as part of the present invention. In the present embodiment, the circular cross-section allows the door panel to swivel about the door hanger about an axis defined through the center of the circular cross-section, such that the final resting position of the door panel can be customized for each application, such resting position being determined by the alignment requirements between the door panel, the door panel operator and the passageway that the door panel is required to cover during operation.

FIG. 2 is a diagrammatic illustration of an example of the engagement 65 between a door hanger 10 and a portion of a door panel 70. In the embodied arrangement, a top rail portion 80 of the door panel 70 is slid around the door hanger 10 such that a reciprocating cavity in the top rail portion 80 fits around the door panel interface 30 of the door hanger 10. In one embodiment, the top rail portion 80 may be an integral part of the door panel 70. In another embodiment, the top rail portion 80 may be an add-on component to the door panel 70. In such instances, it is proper to assume that the door panel 70 and the top rail portion 80 may be fastened together using any fastening method known in the art. Such an arrangement proves invaluable for retrofitting operation on a pre-existing door that may not directly engage with the door hanger envisioned by the present invention.

In the illustrated embodiment of FIG. 2, the top rail portion 80 comprises a first lip portion 90 and a second lip portion 100, the lip portions 90, 100 being adapted to wrap around the door panel interface 30 of the door hanger 10 while allowing some relative movement between the door panel 70 and the door hanger 10 prior to being fixed in position. This arrangement allows the door panel 70 to swivel about the door hanger 10 until a desired resting position for the door panel 70 is reached. Such a resting position facilitates the door panel 70 to function, such as open and close operations, properly without any additional wear and/or stress to the door panel 70 and/or to the door operator. Although a substantially circular cross section is illustrated for the door panel interface 30 and the reciprocating cavity of the door panel top rail 80, any shape capable of allowing the hanger 10 and the door panel 50 to swivel or pivot about one another is contemplated by the invention.

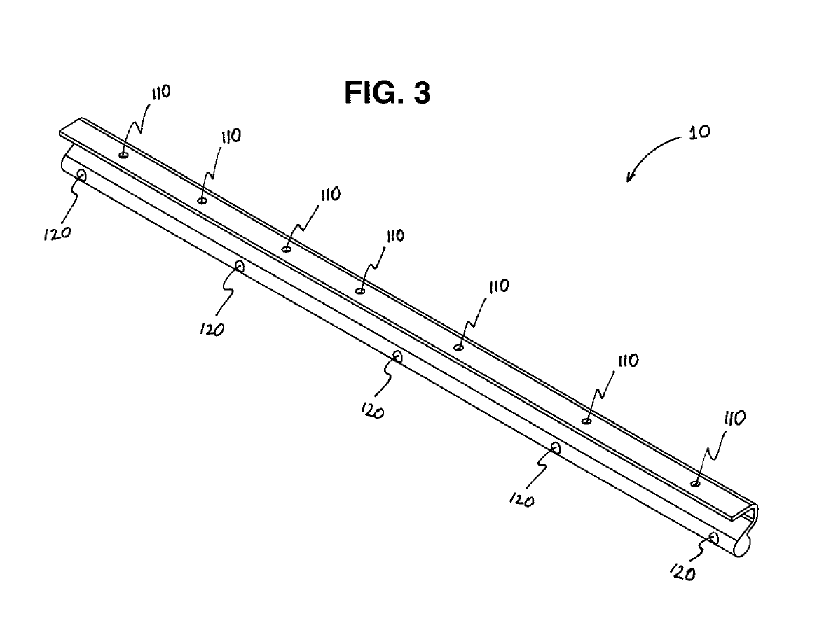

FIG. 3 is an illustration of another embodiment of the door hanger 10 showing its cross-sectional as well as angular views. In addition to the features already described hereinabove, a plurality of apertures may be present on the door operator interface 20 and the door panel interface 30. The first plurality of apertures 110 on the first leg of the door operator interface 20 are present to help fasten the door hanger 10 to the door operator. The door operator may comprise any number of assemblies. For example, the door operator interface 30 may engage an overhead track, a drive mechanism, or an automatic actuating mechanism for opening and closing the door panel 70. The size and shape of the apertures 110 are determined by the choice of fasteners used to secure the door hanger to the door operator. Further, the spacing between the apertures 110 is not required to be constant. When the fastening means is by non-mechanical means, the apertures may be replaced with a plurality of protrusions or cavities with corresponding cavities and protrusions respectively on the door operator to allow for creation of a strong bond between the door hanger and the door operator during application of a suitable chemical or metallurgical bonding techniques such as using adhesives or welding techniques known in the art.

Similarly, the door panel interface 20 of the door hanger 10 includes a second plurality of apertures 120 to allow fastening of the door panel 70 around the door hanger 10 once the final resting position of the door panel has been determined.

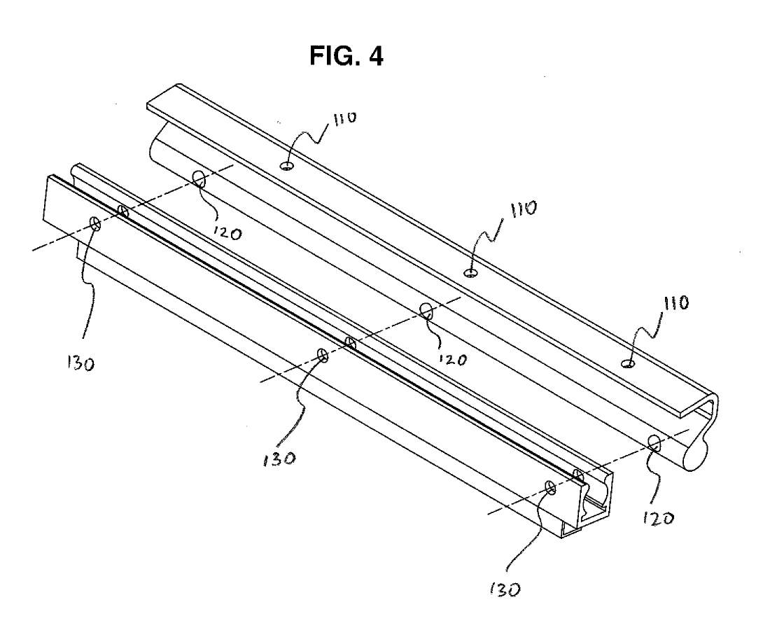

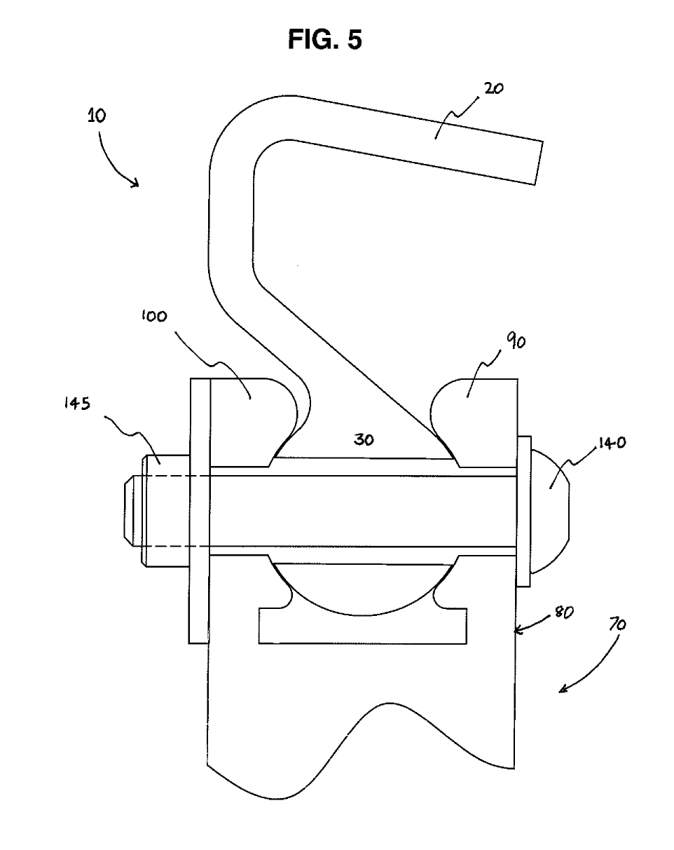

FIG. 4 is an illustration of an engagement between the door hanger 10 and the door panel 70 that includes the top rail portion 80. In addition to the apertures 110, 120 on the door hanger 10, the figure also illustrates a pair of third plurality of apertures 130 placed in a pattern that matches and coincides with the pattern of apertures 120 on the door hanger 10. Each of the pair of apertures 130 is present on the top rail portion 80 such that there is one aperture 130 on each lip portion 90 and 100. Proper pattern matching of the apertures 120 and 130 along the door hanger 10 and the top rail portion 80 allows proper fixing of the door panel 70 once the desired resting position is reached. In one example, a mechanical fastening means such as a bolt 140 (shown in FIG. 5) is inserted through each of the pairs of apertures 120, and 130 to secure the door panel in its resting position. In order for the door panel 70 to be pivotable, the bore of each of the aperture 120 is preferably larger than the bore of the corresponding aperture 130.

FIG. 5 is a diagrammatic illustration of one embodiment of securing the door panel 70 about its door hanger 10 once a final resting position is reached. It is also now apparent that any fastening means, such as a bolt 140 and nut 145 arrangement as shown in FIG. 5, will result in closing of the lip portions 90 and 100 around the door hanger 10 such that the door panel 70 is held in the desired position. Furthermore, the FIG. 5 also illustrates the relative size difference between the apertures in the door hanger 10 and the apertures in the door panel top rail portion 80. The bore of the apertures in both the door panel interface 30 and the top rail portion 80 may be circular in cross-section, and having a diameter of d1 and d2, respectively. In one embodiment, d1 may be greater than or at least equal to d2. For example, when d1 is greater than d2, the head of bolt 140 and nut 145 may contact only the lip portions 90, 100, thereby squeezing the top rail 80 around the door panel interface 30, with the bolt extending through the aperture in the door panel interface 30 without contacting the door panel interface 30. Each of the plurality of apertures 120 on the door panel interface may be of a different dimension, and as long as each corresponding aperture in the top rail portion 80 of the door panel 70 varies in accordance with the preferred difference in dimension. Such variations are contemplated by the present invention as disclosed.

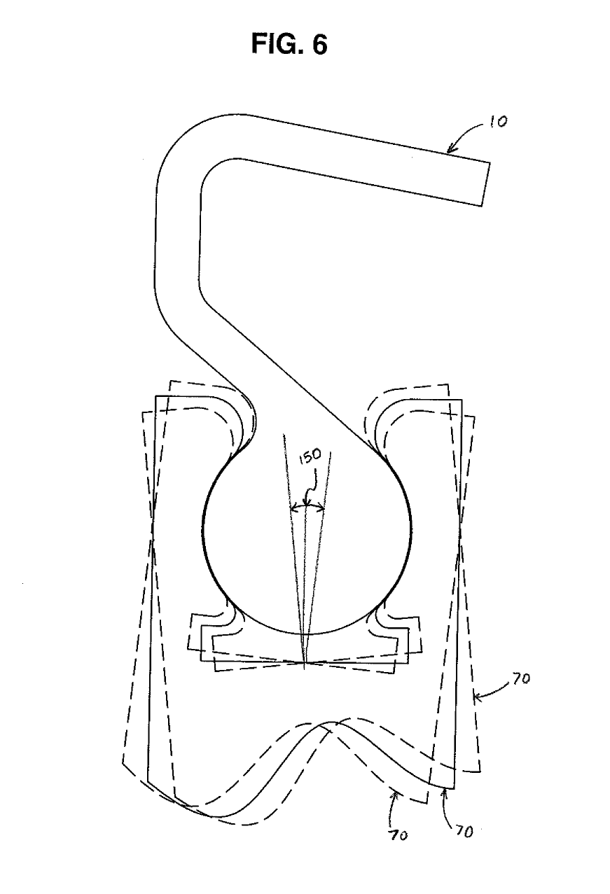

As shown in FIG. 6, the top rail portion 80 of the door panel can be rotated about the door panel interface 30 of the door hanger 10. The angle of swivel or pivot 150 is defined as a maximum angle by which the door panel 70 can swivel or pivot around the door hanger 10. Depending on the needs of the particular application and dimensions of the components, the angle of swivel or pivot 150 may vary. For example, in one embodiment, the angle of swivel or pivot is 12 degrees.

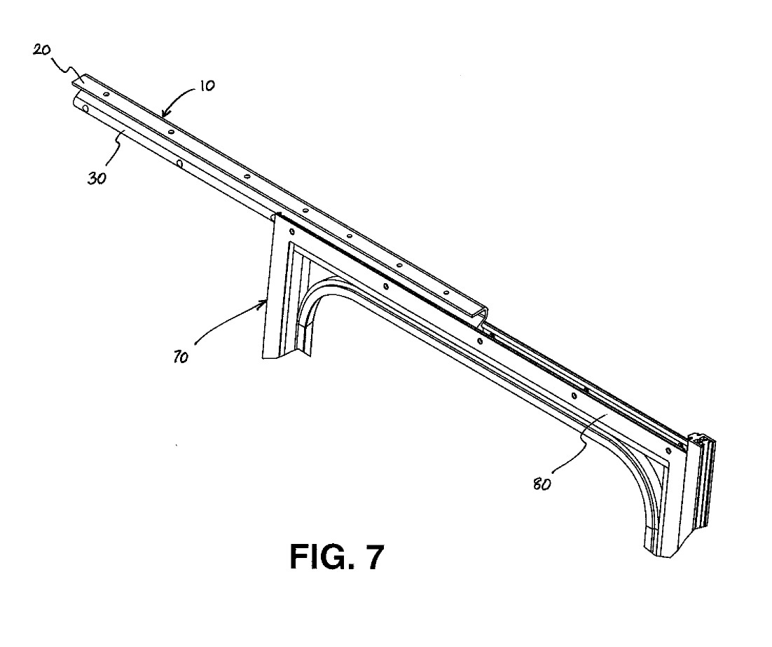

FIG. 7 is a diagrammatic illustration of a door hanger 10 and a partially assembled door panel when seen at an angle. In accordance with one aspect of the present invention, the method of fitting a door panel to a vehicle will first require the operation of fitting the door hanger's door operator interface 20 to the door operator. Once the door hanger 10 is securely fastened to the door operator, the door panel 70 containing the top rail portion 80 may be slid around the door hanger's door panel interface 30. The door panel's top rail portion 80 is adjusted such that the plurality of apertures in the top rail portion 80 and the plurality of apertures in the door panel interface coincide. Subsequently, fastening means, such as a bolt, is inserted through each of the pairs of apertures such that the bolt clearly exits the aperture at the opposing end of the top rail portion. The position of the top rail portion and thereby the door panel is adjusted until a desired position and/or alignment of the door panel is achieved. The bolt is securely fastened and tightened with a nut until the lip portions 90, 100 of the top rail portion 80 tightly grasp the door panel interface such that the door panel's position remains unaltered thereafter.

In accordance with another aspect of the present invention, a method of fitting a door panel to a door operator may involve an additional step of fastening the top rail portion 80 to the door panel 70 before any of the steps described in the previous aspect describing a method of fitting the door panel. In accordance with yet another embodiment of the present invention, a method of fitting a door panel to a door hanger may include the step of sliding the door hanger into the top rail portion of the door panel prior to fixing the door hanger to the door operator. In this embodiment, once the door hanger is secured to the door operator, the door panel is adjusted to its desired resting position and fastened into place.

The choice of materials for preparation of the door hanger and/or the top rail portion may include stainless steel, carbon steel, aluminum, anodized steel, titanium, manganese, copper, nickel, zinc and any known types of plastic polymers including high density polyethylene (HDPE). In some instances, alloys containing portions of one or more of the above specified metals may also be used. The method of producing the top rail portion and/or the door hanger may include an extrusion process utilizing any of the above specified materials. The extrusion process may include linear extrusions, or impact extrusions. In another embodiment, the method of producing the top rail portion and/or the door hanger may be produced by stamping, punching, powder metal compaction, plastic extrusion, milling (including CNC milling) techniques and photochemical machining processes. Using a combination of one or more of the techniques specified above are contemplated by the present invention in creating some or all portions of the door hanger and/or the top rail portion.

In accordance with one aspect of the present invention, once the door panel is fixed about its final resting position, the position cannot be changed. In other implementations, the position can be changed during maintenance intervals so that optimal performance of the door panels about the vehicle can be attained during regular preventive maintenance periods.

While several embodiments of an adjustable door hanger and a method of hanging a door have been described in the foregoing detailed description, those skilled in the art may make modifications and alterations to these embodiments without departing from the scope and spirit of the invention. Accordingly, the foregoing description is intended to be illustrative rather than restrictive.

The invention claimed is:

1. A hanger for a sliding door assembly, comprising:
an operator interface; and
a door panel interface connected to the operator interface,
wherein the door panel interface is adapted to adjustably engage a portion of a door panel such that the door panel is pivotable about the door panel interface.

2. The hanger of claim 1, wherein the door panel is pivotable to a desired resting position, wherein the door panel interface is adapted to allow for fixing the door panel in the desired resting position.

3. The hanger of claim 1, further comprising a door panel top rail, wherein the door panel interface is adjustably engaged with the door panel top rail such that the door panel top rail is pivotable about the door panel interface, the door panel top rail being attached to a portion of the door panel, such that the door panel is pivotable about the door panel interface.

4. The hanger of claim 1, wherein the operator interface is adapted to engage a door operator assembly.

5. The hanger of claim 4, wherein the operator interface comprises a first leg and a second leg, wherein
the first leg includes a first end and a second end; and
the second leg includes a first end and a second end;
wherein the second end of the first leg and the first end of the second leg are connected, and the second end of the second leg is connected to the door panel interface.

6. The hanger of claim 5, wherein the operator interface further comprises a neck portion, the neck portion connecting the second end of the second leg to the door panel interface.

7. The hanger of claim 5, wherein the first leg and the second leg are in a substantially L-shaped configuration.

8. The hanger of claim 1, wherein the door panel interface comprises a substantially circular cross-section, wherein the door panel, engaged to the door panel interface, is pivotable about an axis defined through the center of the substantially circular cross-section of the door panel interface.

9. The hanger of claim 1, wherein the operator interface and the door panel interface are integrally formed.

10. The hanger of claim 1, wherein the first leg comprises a first plurality of apertures, and further comprising a plurality of operator fasteners, the plurality of fasteners engaging the first plurality of apertures to fix the operator interface to a door operator assembly.

11. The hanger of claim 1, wherein the door panel interface includes a second plurality of apertures, the second plurality of apertures adapted to fix of the door panel in the resting position.

12. The hanger of claim 11, wherein the portion of the door panel attached to the door panel interface includes a first lip portion and a second lip portion, each lip portion comprising a third plurality of apertures at coinciding positions, wherein the second plurality of apertures coincide with the third plurality of apertures and wherein each of the apertures in the second plurality of apertures is larger than the corresponding and coinciding aperture in the third plurality of apertures.

13. The hanger of claim 12, wherein at least one fastener is inserted through at least one aperture of the second plurality of apertures and at least one aperture of the third plurality of apertures to fix the door panel in the desired resting position such that the fastener makes contact with only the first and second lip portions of the door panel.

14. The hanger of claim 1, wherein the door panel is pivotable about the door panel interface to an angle up to 12 degrees.

15. A method of hanging a sliding door panel comprising the steps of
providing a door hanger having an operator interface and a door panel interface connected to the operator interface;
securing the operator interface to an overhead door actuator assembly;
attaching the door panel interface to a door panel such that the door panel is pivotable about the door panel interface;
pivotally adjusting the door panel about the door panel interface; and
securing the door panel and the door panel interface after pivotally adjusting the door panel about the door panel interface, such that the door panel is fixed in position relative to the hanger.

16. The method of hanging a sliding door panel according to claim 15, further comprising the steps of providing a door panel top rail and attaching the door panel top rail to the door panel prior to the step of attaching the door panel interface to the door panel, and wherein the step of attaching the door panel interface to the door panel comprises engaging the door panel interface with the door panel top rail.

17. The method of hanging a sliding door panel according to claim 16, wherein the step of attaching the door panel top rail to the door panel comprises retrofitting a pre-existing door with the door panel top rail.

18. The method of hanging a sliding door panel according to claim 16, wherein the door panel top rail comprises a first lip and a second lip, and the step of engaging the door panel interface with the door panel top rail comprises sliding the door panel interface between the first lip and the second lip of the door panel top rail.

19. The method of hanging a sliding door panel according to claim 15, wherein the step of pivotally adjusting the door panel angularly about the door panel interface comprises pivoting the door panel relative to the hanger, such that the door panel falls to a natural resting position.
